(19) United States
(12) Patent Application Publication
(10) Pub. No.: US 2014/0006992 A1
(43) Pub. Date: Jan. 2, 2014

(54) USER SOURCED DATA ISSUE MANAGEMENT

(71) Applicant: SCHLUMBERGER TECHNOLOGY CORPORATION, Sugar Land, TX (US)

(72) Inventors: Floyd Louis Broussard, III, The Woodlands, TX (US); Rene Radhay, Houston, TX (US)

(73) Assignee: SCHLUMBERGER TECHNOLOGY CORPORATION, Sugar Land, TX (US)

(21) Appl. No.: 13/688,977

(22) Filed: Nov. 29, 2012

Related U.S. Application Data
(60) Provisional application No. 61/667,198, filed on Jul. 2, 2012.

(51) Int. Cl. G06F 3/0484

(52) U.S. Cl. CPC G06F 3/04847
USPC 715/771

(57) ABSTRACT

A method involving operating an exploration and production (E&P) tool in a field. The method includes displaying, in a image generated by a first instantiation of the E&P tool, graphical elements corresponding to objects in the field, receiving, by the first instantiation from a first user, an annotation comprising an issue description regarding a data item in the objects, tagging the annotation onto a graphical element representing the data item, wherein the annotation is stored in a repository and accessible by the first instantiation and a second instantiation of the E&P tool, sending a notification to a second user regarding the annotation, and receiving, by the second instantiation from the second user, a response to the issue description, wherein the response is added to the annotation and stored in the repository.

### CROSS-REFERENCE TO RELATED APPLICATIONS

This application claims priority under 35 U.S.C. §119(e) to Provisional Patent Application No. 61/667,198, filed Jul. 2, 2012, with attorney docket number IS12.2446, and entitled “USER SOURCED DATA ISSUE ASSIGNMENT AND REPORTING/DATA MANAGEMENT DASHBOARD,” which is incorporated herein by reference in its entirety.

### BACKGROUND

Operations, such as geophysical surveying, drilling, logging, well completion, and production, are typically performed to locate and gather valuable downhole fluids. Surveys are often performed using acquisition methodologies, such as seismic mapping, resistivity mapping, etc. to generate images of underground formations. These formations are often analyzed to determine the presence of subterranean assets, such as valuable fluids or minerals, or to determine if the formations have characteristics suitable for storing fluids. Although the subterranean assets are not limited to hydrocarbons such as oil, throughout this document, the terms “oilfield” and “oilfield operation” may be used interchangeably with the terms “field” and “field operation” to refer to a site where any types of valuable fluids or minerals can be found and the activities required to extract them. The terms may also refer to sites where substances are deposited or stored by injecting them into the surface using boreholes and the operations associated with this process. Further, the term “field operation” refers to a field operation associated with a field, including activities related to field planning, wellbore drilling, wellbore completion, and/or production using the wellbore.

Models of subsurface hydrocarbon reservoirs and oil wells are often used in simulation (e.g., in modeling oil well behavior) to increase yields and to accelerate and/or enhance production from oil wells. Seismic interpretation tools and seismic-to-simulation programs can include numerous functionalities and apply complex techniques across many aspects of modeling and simulating. Such programs typically include a large suite of tools and different programs and are referred to as exploration and production (E&P) tools known to those skilled in the art. Users of such systems may spend many hours per day working with these tools in an effort to optimize geological interpretations and reservoir engineering development scenarios.

Within the E&P knowledge workspace, the end users of the interpretation applications (typically geoscientists) are often the most knowledgeable on the data used within the interpretations. In many cases, they have created or requested the acquisition of the data. Due to data governance and management policies, the end users may not be able to alter information they find or believe to be erroneous—and thus must forward or inform a data manager who is the custodian of the information. It typically requires a lot of effort to follow up with the data manager, and to explain what, where, when, and other key context of the data issue.

### SUMMARY

In general, in one aspect, the invention relates to a method for operating an exploration and production (E&P) tool in a field having a subterranean formation. The method includes displaying, in a first image generated by a first instantiation of the E&P tool, a plurality of graphical elements corresponding to a plurality of objects in the field, receiving, by the first instantiation of the E&P tool and from a first user, a first annotation comprising a first issue description regarding a first data item of a wellbore in the plurality of objects, tagging the first annotation onto a first graphical element representing the first data item of the wellbore, wherein the first annotation is stored in a repository and accessible by the first instantiation of the E&P tool and a second instantiation of the E&P tool, sending a first notification to a second user regarding the first annotation, and receiving, by a computer processor executing the second instantiation of the E&P tool and from the second user, a first response to the first issue description, wherein the first response is added to the first annotation and stored in the repository, wherein the first response is accessible from the repository by the first user using the first instantiation of the E&P tool.

Other aspects of the invention will be apparent from the following detailed description and appended claims.

### BRIEF DESCRIPTION OF DRAWINGS

The appended drawings illustrate several embodiments of user sourced data issue management and are not to be considered limiting of its scope, for user sourced data issue assignment and reporting may admit to other equally effective embodiments.

FIG. 1.1 is a schematic view, partially in cross-section, of a field in which one or more embodiments of user sourced data issue management may be implemented.

FIG. 1.2 shows an exploration and production modeling system in accordance with one or more embodiments.

FIG. 2 shows a flow chart of a method for user sourced data issue management in accordance with one or more embodiments.

FIGS. 3.1-3.7 depict an example for user sourced data issue management in accordance with one or more embodiments.

FIG. 4 depicts a computer system using which one or more embodiments of user sourced data issue management may be implemented.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

Aspects of the present disclosure include a method, system, and computer readable medium to allow an end user of an E&P tool to tag a data item as having a possible issue, such that other users in a community can share the information. The data item may be a location or other data associated with an object in the field (e.g., a wellbore, hydrocarbon reservoir, formation layer, etc.). In one or more embodiments, an issue description is tagged to the data item as an annotation. Generally, the annotation is a virtual tag assigned to a location or other data, and can include text, links, images, documents, etc. regarding the possible issue concerning the data item. In one or more embodiments, the type of an annotation can be specified by the selection of a graphical icon that gives the other users an understanding of the nature of the annotation, e.g., basic informative, notification, alert, etc. Throughout this disclosure, the term “object” refers to a physical item in the field, the term “data item” refers to data describing one or more attributes of the object, and the term “graphical element” refers to a displayed element in a graphical user interface (GUI) of the E&P tool. In particular, the graphical element may representing one or more object(s), data item(s) associated with the object(s), or annotations(s) tagged to the data item(s). The graphical element may also be a component of the GUI, such as a radio button, textbox, drop-down list, etc. Further, the term “instantiation” refers to an occurrence, session, or a copy of a software application, whether currently executing or not.

The data item and the annotation are part of a larger data set that is stored in a shared repository accessible by a data manager, who would be notified. The notification may be via an email or other interface for the data manager to view the issue description with its context (e.g., location, related data, reporting user information, nature of the error, time of reporting, etc). Multiple issue descriptions reported by multiple users may be organized in a metadata list. This list may be viewable in 2D and/or 3D format for the data manager to quickly determine the nature and validity of reported data issues, such that proper actions are taken to resolve them. Once the data is corrected or the issue closed, the reporting user is notified of the update with the corresponding action noted in the annotation and history of the data item.

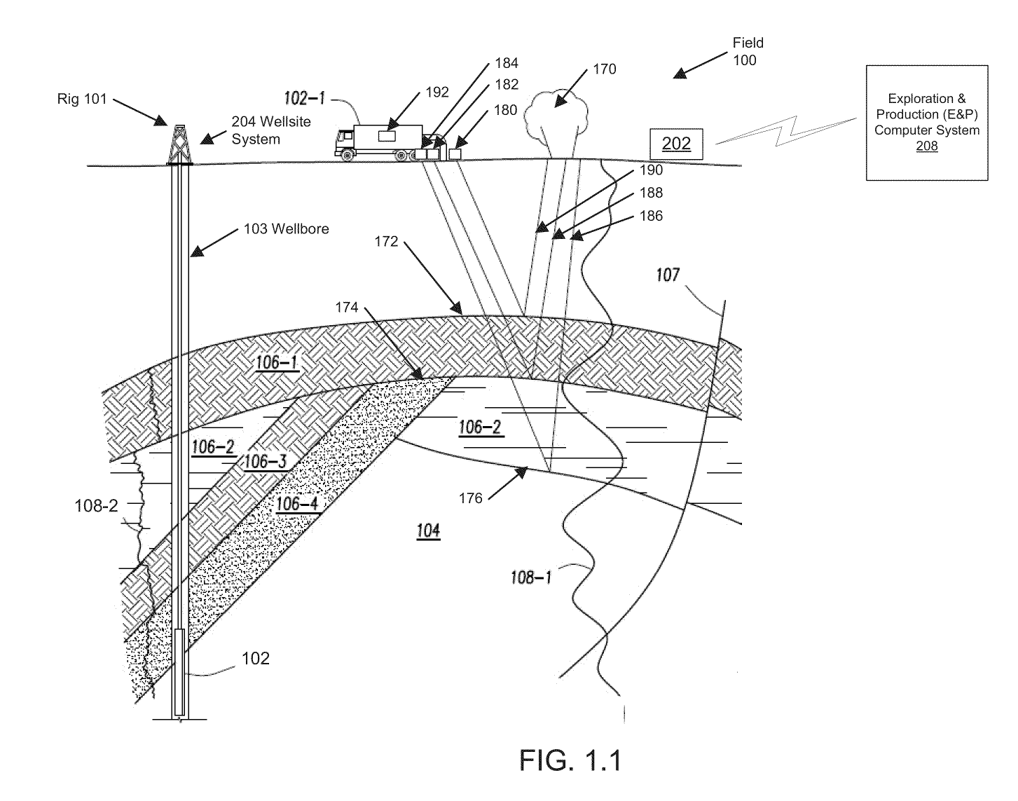

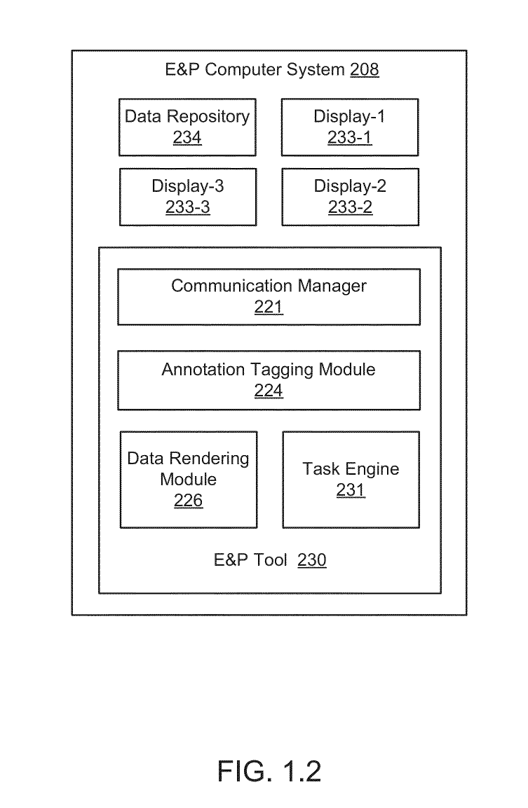

FIG. 1.1 depicts a schematic view, partially in cross section, of a field (100) in which one or more embodiments of user sourced data issue management may be implemented. In one or more embodiments, one or more of the modules and elements shown in FIG. 1.1 may be omitted, repeated, and/or substituted. Accordingly, embodiments of user sourced data issue management should not be considered limited to the specific arrangements of modules shown in FIG. 1.1.

As shown in FIG. 1.1, the subterranean formation (104) includes several geological structures (106-1 through 106-4). As shown, the formation has a sandstone layer (106-1), a limestone layer (106-2), a shale layer (106-3), and a sand layer (106-4). A fault line (107) extends through the formation. In one or more embodiments, various survey tools and/or data acquisition tools are adapted to measure the formation and detect the characteristics of the geological structures of the formation. As noted above, the outputs of these various survey tools and/or data acquisition tools, as well as data derived from analyzing the outputs, are considered as part of the historic information.

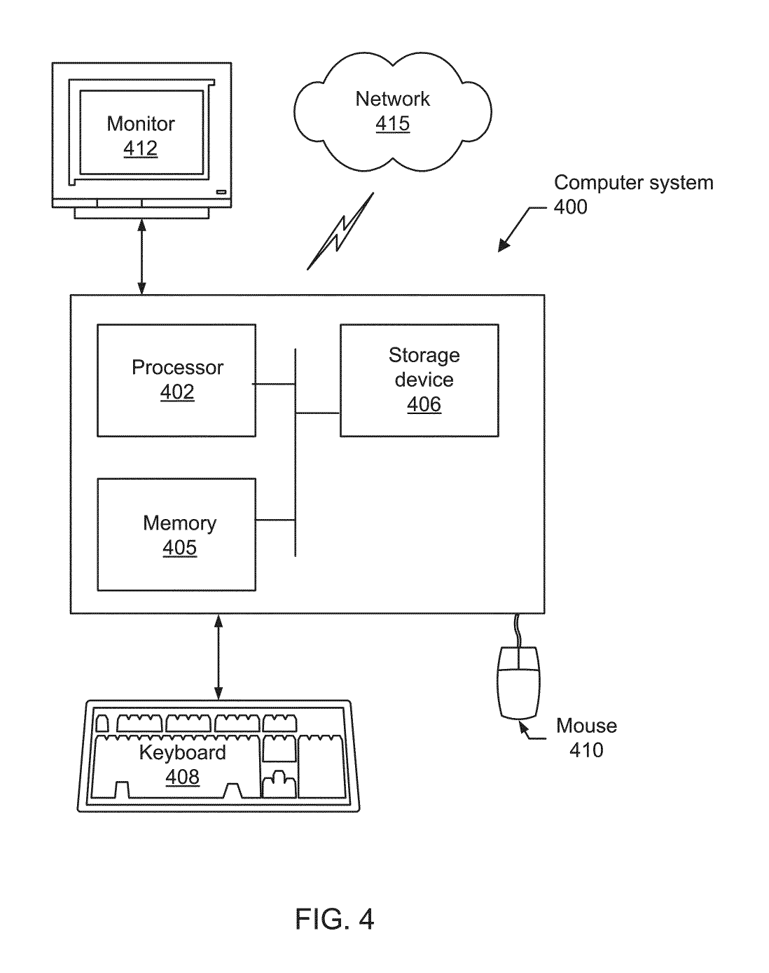

As shown in FIG. 1.1, seismic truck (102-1) represents a survey tool that is adapted to measure properties of the subterranean formation in a seismic survey operation based on sound vibrations. One such sound vibration (e.g., 186, 188, 190) generated by a source (170) reflects off a plurality of horizons (e.g., 172, 174, 176) in the subterranean formation (104). Each of the sound vibrations (e.g., 186, 188, 190) are received by one or more sensors (e.g., 180, 182, 184), such as geophone-receivers, situated on the earth's surface. The geophones produce electrical output signals, which may be transmitted, for example, as input data to a computer (192) on the seismic truck (102-1). Responsive to the input data, the computer (192) may generate a seismic data output, which may be logged and provided to a surface unit (202) by the computer (192) for further analysis. The computer (192) may be the computer system shown and described in relation to FIG. 4.

Further as shown in FIG. 1.1, the wellsite system (204) is associated with a rig (101), a wellbore (103), and other wellsite equipment and is configured to perform wellbore operations, such as logging, drilling, fracturing, production, or other applicable operations. Generally, survey operations and wellbore operations are referred to as field operations of the field (100). These field operations are typically performed as directed by the surface unit (202).

In one or more embodiments, the surface unit (202) is operatively coupled to the computer (192) and/or a wellsite system (204). In particular, the surface unit (202) is configured to communicate with the computer (192) and/or the data acquisition tool (102) to send commands to the computer (192) and/or the data acquisition tools (102) and to receive data therefrom. For example, the data acquisition tool (102) may be adapted for measuring downhole properties using logging-while-drilling (“LWD”) tools. In one or more embodiments, surface unit (202) may be located at the wellsite system (204) and/or remote locations. The surface unit (202) may be provided with computer facilities for receiving, storing, processing, and/or analyzing data from the computer (192), the data acquisition tool (102), or other part of the field (104). The surface unit (202) may also be provided with or functionally for actuating mechanisms at the field (100). The surface unit (202) may then send command signals to the field (100) in response to data received, for example to control and/or optimize various field operations described above.

In one or more embodiments, the data received by the surface unit (202) represents characteristics of the subterranean formation (104) and may include seismic data and/or information related to porosity, saturation, permeability, natural fractures, stress magnitude and orientations, elastic properties, etc. during a drilling, fracturing, logging, or production operation of the wellbore (103) at the wellsite system (204). For example, data plot (108-1) may be a seismic two-way response time or other types of seismic measurement data. In another example, data plot (108-2) may be a wireline log, which is a measurement of a formation property as a function of depth taken by an electrically powered instrument to infer properties and make decisions about drilling and production operations. The record of the measurements, typically on a long strip of paper, may also be referred to as a log. Measurements obtained by a wireline log may include resistivity measurements obtained by a resistivity measuring tool. In yet another example, the data plot (108-2) may be a plot of a dynamic property, such as the fluid flow rate over time during production operations. Those skilled in the art will appreciate that other data may also be collected, such as, but not limited to, historical data, user inputs, economic information, other measurement data, and other parameters of interest.

In one or more embodiments, the surface unit (202) is communicatively coupled to an exploration and production (E&P) computer system (208). In one or more embodiments, the data received by the surface unit (202) may be sent to the E&P computer system (208) for further analysis. Generally, the E&P computer system (208) is configured to analyze, model, control, optimize, or perform other management tasks of the aforementioned field operations based on the data provided from the surface unit (202). In one or more embodiments, the E&P computer system (208) is provided with functionality for manipulating and analyzing the data, such as performing seismic interpretation or borehole resistivity image log interpretation to identify geological surfaces in the subterranean formation (104) or performing simulation, planning, and optimization of production operations of the wellsite system (204). In one or more embodiments, the result generated by the E&P computer system (208) may be displayed for user viewing using a 2 dimensional (2D) display, 3 dimensional (3D) display, or other suitable displays. Although the surface unit (202) is shown as separate from the E&P computer system (208) in FIG. 1.1, in other examples, the surface unit (202) and the E&P computer system (208) may also be combined.

FIG. 1.2 shows more details of the E&P computer system (208) in which one or more embodiments of user sourced data issue management may be implemented. In one or more embodiments, one or more of the modules and elements shown in FIG. 1.2 may be omitted, repeated, and/or substituted. Accordingly, embodiments of user sourced data issue management should not be considered limited to the specific arrangements of modules shown in FIG. 1.2.

As shown in FIG. 1.2, the E&P computer system (208) includes E&P tool (230) having task engine (231) and data rendering module (226), annotation tagging module (224), communication manager (221), data repository (234), and displays (e.g., display-1 (233-1), display-2 (233-2), display-3 (233-3)). Each of these elements is described below.

In one or more embodiments, the E&P computer system (208) includes the E&P tool (230) having software instructions stored in a memory and executing on a processor to communicate with the surface unit (202) for receiving data therefrom and to manage (e.g., analyze, model, control, optimize, or perform other management tasks) the aforementioned field operations based on the received data. In one or more embodiments, the received data is stored in the data repository (234) to be processed by the E&P tool (230). One or more field operation management tasks (e.g., analysis task, modeling task, control task, optimization task, etc.) may be performed in an execution pass of the E&P tool (230), referred to as an E&P tool session. During the E&P tool session, the received data is manipulated by the task engine (231) to generate, continuously or intermittently, preliminary results that are rendered and displayed to the user using the data rendering module (226) and a display (e.g., display-1 (233-1), display-2 (233-2), or display-3 (233-3)) assigned to the user, respectively. For example, the E&P tool session may be a seismic interpretation session where the task engine (231) processes the seismic data set and the data rendering module (226) renders interpreted seismic results to be displayed to the user using the display (e.g., display-1 (233-1), display-2 (233-2), or display-3 (233-3)). In one or more embodiments, one or more of the display-1 (233-1), display-2 (233-2), and display-3 (233-3) may be a 2D display, a 3D display, or other suitable display device. In one or more embodiments, each of multiple users may launch a separate instantiation/session (i.e., an occurrence or a copy, whether currently executing or not) of the E&P tool (230) to access shared data set in the data repository (234). For example, the display-1 (233-1), display-2 (233-2), and display-3 (233-3) may be used by three users to separately view results of their E&P tool sessions. As noted above, the term “object” refers to a physical item in the field (e.g., wellbore (103), geological structures (106-1 through 106-4), reservoir, etc. in the field (100) of FIG. 1.1), the term “data item” refers to data describing one or more attributes (e.g., location) of the object, and the term “graphical element” refers to a displayed element in a graphical user interface (GUI) of the E&P tool (230). In particular, the graphical element may be in the GUI displayed by the display-1 (233-1), display-2 (233-2), or display-3 (233-3) and represents one or more object(s), data item(s) associated with the object(s), or annotations(s) tagged to the data item(s). Further, the graphical element may also be a component of the GUI, such as a radio button, textbox, drop-down list, etc.

The processor and memory of the E&P computer system (208) are not explicitly depicted in FIG. 1.2 so as not to obscure other elements of the E&P computer system (208). An example of such processor and memory is described in reference to FIG. 4 below.

In one or more embodiments, the E&P computer system (208) includes a communication manager (221) that is configured to allow a user of the E&P tool (230) to communicate with another user of the E&P tool (230). In one or more embodiments, the E&P computer system (208) includes an annotation tagging module (224) that is configured to receive an issue description from a first user (referred to as the data reporting user, e.g., a geologist) while the data reporting user is viewing a subterranean formation field data set using a first instantiation of the E&P tool (230) (referred to as the issue reporting instantiation). Specifically, the issue description describes a potential issue concerning a data item in the subterranean formation field data set. In one or more embodiments, the annotation tagging module (224) is instantiated as part of the issue reporting instantiation that receives the issue description. Further, this instantiation of the annotation tagging module (224) combines a configuration parameter (e.g., camera angle of the view in a 3D spatial window when note was captured, colors, zoom level, etc.) of the issue reporting instantiation and the issue description into an annotation, and stores the annotation in the data repository (234). Further, the annotation is tagged onto a graphical element representing the data item and displayed in a first image (referred to as the issue reporting image) generated by the data rendering module (226) (instantiated as part of the issue reporting instantiation). In one or more embodiments, the communication manager (221) (instantiated as part of the issue reporting instantiation) sends a notification to a second user (referred to as a data manager user) regarding the annotation generated/tagged by the data reporting user. For example, the data manager user may have launched or will launch, in response to the notification, a second instantiation of the E&P tool (230) (referred to as the data manager instantiation).

In one or more embodiments, in response to the notification, the data manager instantiation of the E&P tool (230) generates a second image (referred to as the data manager image) as a reproduction of the issue reporting image for displaying to the data manager user. Specifically, the annotation tagging module (224) (instantiated as part of the data manager instantiation) retrieves the annotation from the data repository (234) to extract the issue description associated with the data item and the configuration parameter of the issue reporting instantiation. In one or more embodiments, the data rendering module (226) (instantiated as part of the data manager instantiation) reproduces the issue reporting image based on the configuration parameter of the issue reporting instantiation to generate the data manager image. Accordingly, the data item and the issue description are displayed in the data manager image for analysis by the data manager user. As noted above, the data manager user may be a data manager who analyzes the data item based on the issue description to generate a response to address the reported (potential) issue. In one or more embodiments, the response is added as an update to the annotation stored in the data repository (234) and a notification of the response is sent to the data reporting user.

The data repository (234) (and/or any of the data set, data item, annotation, etc. stored therein) may be a data store such as a database, a file system, one or more data structures (e.g., arrays, link lists, tables, hierarchical data structures, etc.) configured in a memory, an extensible markup language (XML) file, any other suitable medium for storing data, or any suitable combination thereof. The data repository (234) may be a device internal to the E&P computer system (208). Alternatively, the data repository (234) may be an external storage device operatively connected to the E&P computer system (208).

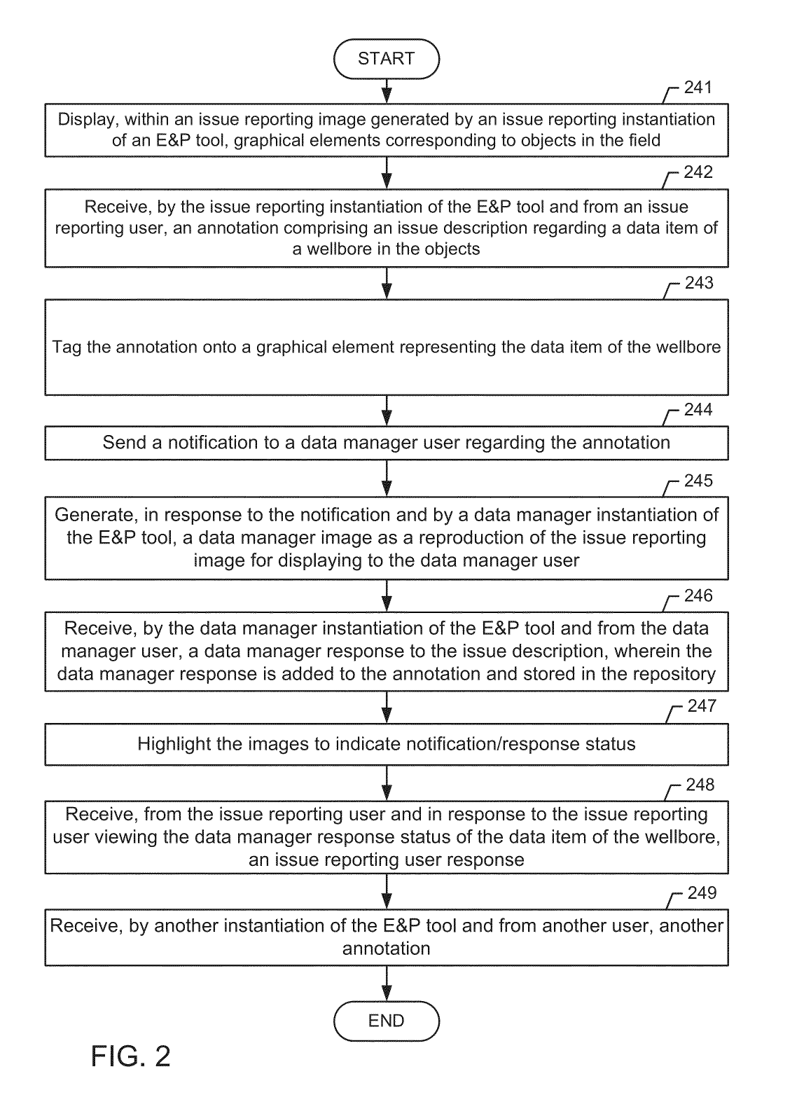

FIG. 2 shows a flow chart of a method for user sourced data issue management in accordance with one or more embodiments. In one or more embodiments, one or more of the elements shown in FIG. 2 may be omitted, repeated, and/or performed in a different order. Accordingly, embodiments of user sourced data issue management should not be considered limited to the specific arrangements of elements shown in FIG. 2.

In one or more embodiments, the method depicted in FIG. 2 may be practiced based on the schematic view described with respect to FIGS. 1.1 and 1.2 above. Throughout the discussion of FIG. 2, the term “object” refers to a physical item in the field (e.g., wellbore, geological structures, reservoir, etc), the term “data item” refers to data describing one or more attributes (e.g., location) of the object, and the term “graphical element” refers to a displayed element in a graphical user interface (GUI) of the E&P tool. In particular, the graphical element may represent one or more object(s), data item(s) associated with the object(s), or annotations(s) tagged to the data item(s). Further, the graphical element may also be a component of the GUI, such as a radio button, textbox, drop-down list, etc. Further, viewing an object in the field and/or viewing a data item refer to viewing a corresponding graphical element representing the data item of the object using the graphical user interface of the E&P tool.

In one or more embodiments, the data item of an object (e.g., the wellbore) includes one or more of a wireframe representing the object (e.g., the wellbore), a pixel image representing the object (e.g., the wellbore), a test log associated with the object (e.g., the wellbore), and a report file associated with the object (e.g., the wellbore).

Initially, in Element 241, graphical elements are displayed in a first image (referred to as the issue reporting image) generated by a first instantiation of an exploration and production (E&P) tool. The first instantiation is referred to as an issue reporting instantiation. As noted above, models of subsurface structures (e.g., subterranean layers, hydrocarbon reservoirs and oil wells) in a field are often used in simulation to plan field productions and to accelerate and/or enhance production from wells. Seismic interpretation tools and seismic-to-simulation programs are examples of E&P tools. The issue reporting image is a component of a graphical user interface window of the E&P tool used by a first user (referred to as the issue reporting user). For example, the issue reporting user may use the issue reporting instantiation of the E&P tool to perform planning or simulation for an oilfield. In one or more embodiments, the displayed graphical elements correspond to objects (e.g., subterranean layers, hydrocarbon reservoirs and oil wells) in the field. Accordingly, the issue reporting image represents these objects in the field to the issue reporting user during the planning or simulation.

From time to time, the issue reporting user relies on his/her knowledge and experience to spot issues with the data items during the planning or simulation using the E&P tool. In Element 242, an annotation is received by the issue reporting instantiation of the E&P tool and from the issue reporting user. In one or more embodiments, the annotation is regarding an issue of a data item of a wellbore in the aforementioned objects in the field. Specifically, the annotation includes an issue description describing the issue of the data item of the wellbore. Example issue descriptions may relate to an error in the wellbore trajectory in the wireframe or pixel image, an error in the units for the test log that need to be corrected, or a version of the report file that needs to be validated as to whether the report file is up-to-date.

In one or more embodiments, the issue description is received from the issue reporting user via a user issue description window. In particular, the user issue description window is associated with the data item of the wellbore. Specifically, the user issue description window is displayed in response to the issue reporting user clicking on the graphical element. Accordingly, the issue reporting user may type text description of the issue into the user issue description window. In one or more embodiments, the user issue description window is superimposed on the issue reporting image. In one or more embodiments, the user issue description window is displayed separate from (e.g., adjacent to) the issue reporting image.

In one or more embodiments, the annotation further includes a type of the issue description. In other words, issue descriptions may be of different types. One example type of issue description provides information regarding the data item of the object, such as a note regarding a location of the wellbore. Another example type of issue description provides information regarding an action applied to the data item of the object, such as a note regarding a need to update the location of the wellbore. Yet another example type of issue description provides information regarding a problem with the data item of the object, such as a note regarding a suspected error in the location of the wellbore.

In one or more embodiments, the annotation is stored in a repository and accessible by multiple users of the E&P tool. For example, the annotation is accessible from the repository by the issue reporting user using the issue reporting instantiation of the E&P tool and by another user using a data manager instantiation of the E&P tool. In one or more embodiments, the issue reporting instantiation of the E&P tool and the data manager instantiation of the E&P tool execute on separate computer processors. For example, each instantiation of the E&P tool may execute on a different node of a computer network.

In Element 243, the annotation is tagged onto a graphical element representing the data item of the wellbore.

In Element 244, a notification is sent to a second user (referred to as the data manager user) regarding the annotation. In one or more embodiments, the data manager user is assigned as a data manager to maintain integrity of the data items related to the aforementioned objects in the field. Specifically, the data manager user may use the data manager instantiation of the E&P tool to view, address, and resolve reported issues from other users of the E&P tool.

In Element 245, a second image (referred to as the data manager image) is generated, in response to the notification and by the data manager instantiation of the E&P tool, for displaying to the data manager user. In particular, the data manager image is a component of a graphical user interface window of the E&P tool. Specifically, the data manager user uses this graphical user interface window of the E&P tool to view, or otherwise receive notifications of reported issues from other users of the E&P tool. In one or more embodiments, the data item of the wellbore and the issue description are displayed in the data manager image for analysis by the data manager user. For example, the data manager user analyzes the data item of the wellbore and the issue description in his/her assigned role as the data manager. In one or more embodiments, the data manager instantiation of the E&P tool is launched, automatically or manually in response to a computer node of the data manager user receiving the notification. In one or more embodiments, the data manager instantiation of the E&P tool is already executing when the notification is received by the computer node of the data manager user.

In one or more embodiments, the annotation further includes a configuration parameter (e.g., camera angle, colors, zoom level, image layer configuration, etc. of the view in a 3D spatial window when the annotation was captured) for the issue reporting instantiation of the E&P tool. In such embodiments, the data manager image may be generated as a reproduction of the issue reporting image. Said in other words, the data manager user may view objects in the field using the same camera angle, colors, zoom level, image layer configuration, etc. as the issue reporting user when the issue reporting user annotates the object at issue in the field. Specifically, the data manager image is generated based on the configuration parameter included in the annotation to reproduce the issue reporting image. Accordingly, the data manager user may analyze the data item of the wellbore and the issue description by viewing the same image as the issue reporting user who initially generated the annotation regarding the issue of the data item of the wellbore.

As noted above, by viewing the data manager image, the data manager user analyzes the data item of the wellbore and the issue description in his/her assigned role as the data manager. In Element 246, a first response (referred to as the data manager response) to the issue description is received from the data manager user by the data manager instantiation of the E&P tool. For example, the data manger response may include one or more of “I have corrected the trajectory and please review,” “I have checked the units of the log template and it seems to be correct, please check again,” or “I have updated the file in question to Oct. 23, 2011 version, which is the latest version.” Specifically, the data manager response to the issue description is received in response to displaying the data manager image to the data manager user. In one or more embodiments, the data manager response is added to the annotation and stored in the repository. Accordingly, the data manager response is accessible from the repository by multiple users, such as by the issue reporting user using the issue reporting instantiation of the E&P tool.

In Element 247, the issue reporting image and the data manager image are highlighted to indicate status of annotation, notification, and/or response. Specifically, graphical elements representing the annotation, notification, and/or response are highlighted to indicate their status. For example, the annotation, notification, and/or response may be displayed using different color, hatch pattern, line thickness, or other highlight means known to those skilled in the art. In one or more embodiments, the graphical element representing the data item of the wellbore is highlighted in the data manager image to indicate a notification status with respect to the issue description regarding the data item. In one or more embodiments, the data manager image includes multiple (e.g., 10, 20, 100, etc.) notifications from multiple (e.g., 10, 20, 100, etc.) users. In such embodiments, the issue reporting image may not display all graphical elements representing all objects in the field so as not to obscure viewing of the data manager user. For example, the multiple notification status may be displayed as dots over a map of the field, or simply in a list.

In one or more embodiments, in response to the data manager user viewing the notification status, a request is received from the data manager user to display the issue description such that the data manager user may analyze the reported issue. Accordingly, the data manager user may generate the data manager response. In those embodiments where the data manager image includes multiple (e.g., 10, 20, 100, etc.) notification status from multiple (e.g., 10, 20, 100, etc.) users, the data manager user may select one of the multiple notification status to display the details of the issue description and its corresponding object in the field, so as not to obscure viewing of the data manager user. As described above, the data manager user may view the details of the selected issue description and its corresponding object in the field using the same camera angle, colors, zoom level, image layer configuration, etc. as the particular user when the particular user initially generated the selected issue description.

In one or more embodiments, in response to receiving the data manager response, the data item of the wellbore is further highlighted in the data manager image to indicate a response status of the data item of the wellbore with respect to the data manager response.

In one or more embodiments, in response to receiving the data manager response, the graphical element is also highlighted in the issue reporting image and to indicate, to the issue reporting user, the response status of the data item of the wellbore with respect to the data manager response.

In Element 248, a second response (referred to as the issue reporting user response) is received from the issue reporting user and in response to the issue reporting user viewing the response status of the data item of the wellbore. For example, the issue reporting user response may acknowledge the data manager's response to the reported issue, confirm issue resolution by the data manger's response, or indicate that the data manager's response is insufficient to resolve the reported issue. In one or more embodiments, the issue description, the data manager response, and the issue reporting user response are combined into an issue reporting/resolution log that is stored in the repository. Accordingly, the issue reporting/resolution log of the data item of the wellbore is accessible from the repository by multiple users, e.g., by the issue reporting user using the issue reporting instantiation of the E&P tool and by the data manager user using the data manager instantiation of the E&P tool.

In Element 249, a second annotation is received by a third instantiation (e.g., another instantiation separate from the issue reporting instantiation and the data manager instantiation) of the E&P tool and from a third user (e.g., another user separate from the issue reporting user and the data manager user). For example, the second annotation may report another issue regarding the same data item. As described with respect to the annotation, the second annotation may trigger similar activities and interactions between the third user and the data manager. For example, a second notification may be sent to the data manager regarding the second annotation. As described above, the notification and the second notification are among the multiple notifications from multiple users of the E&P tool. In one or more embodiments, the response from the data manager and the resultant issue reporting/resolution log are also stored in the repository to be accessible by these multiple users.

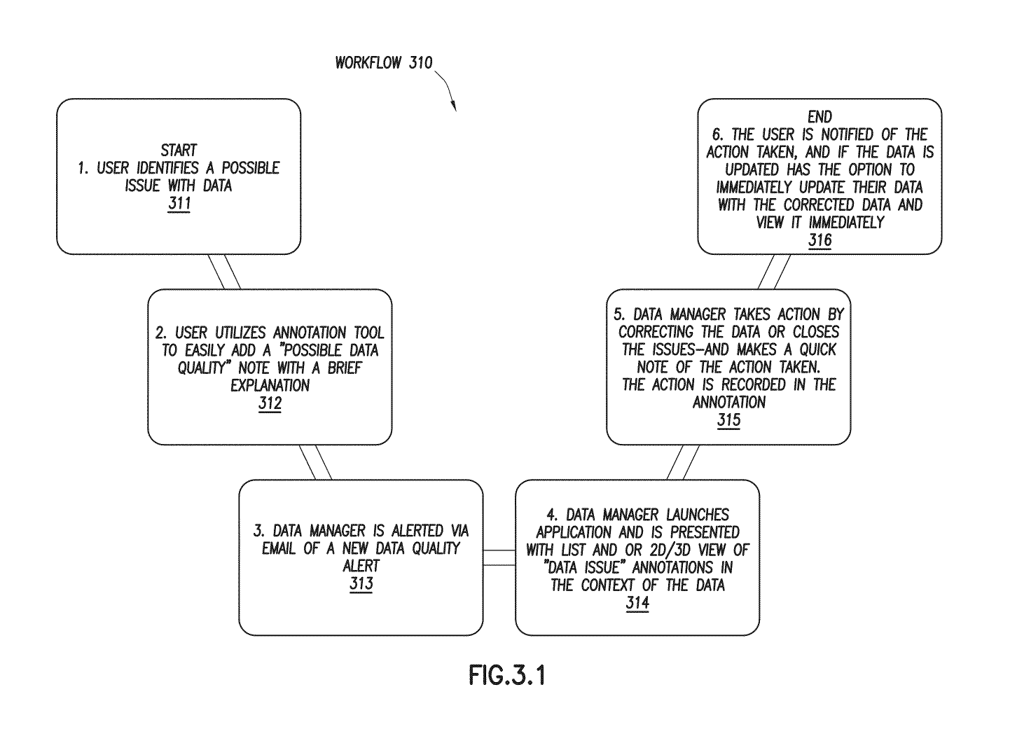

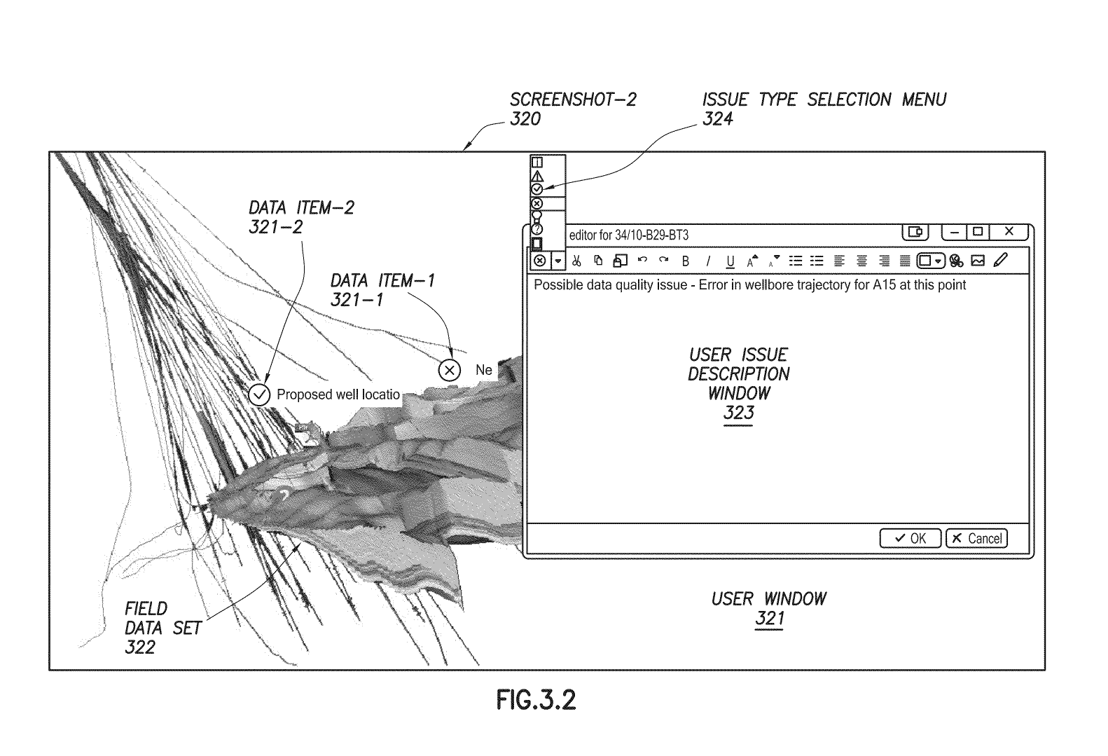

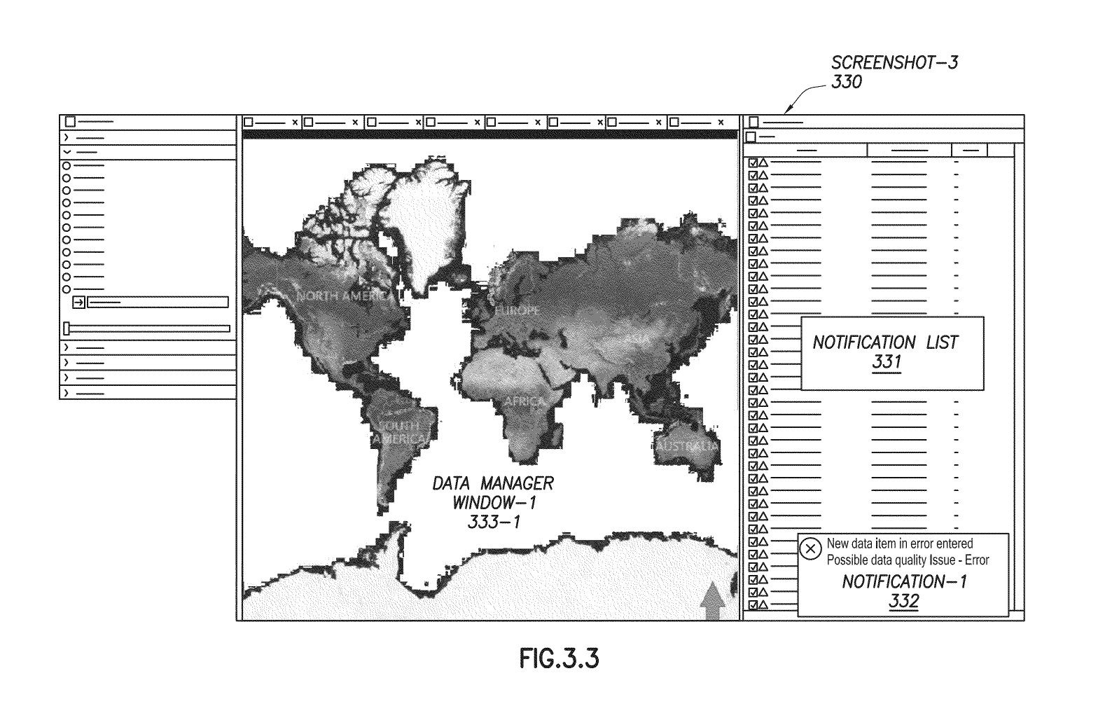

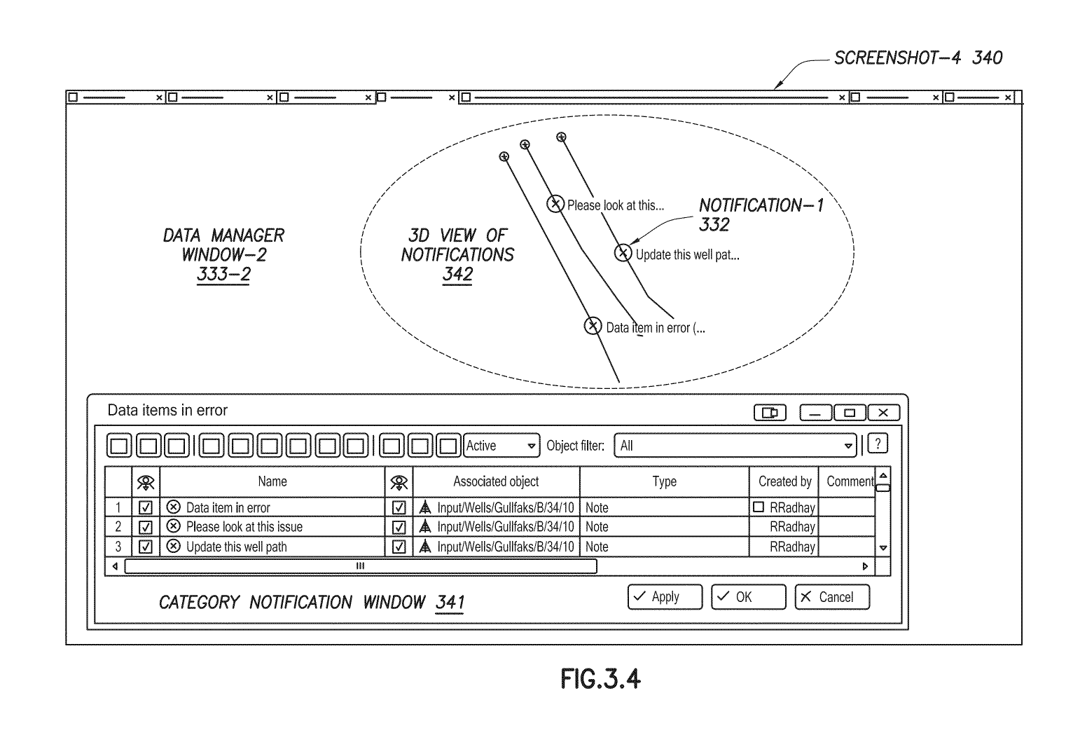

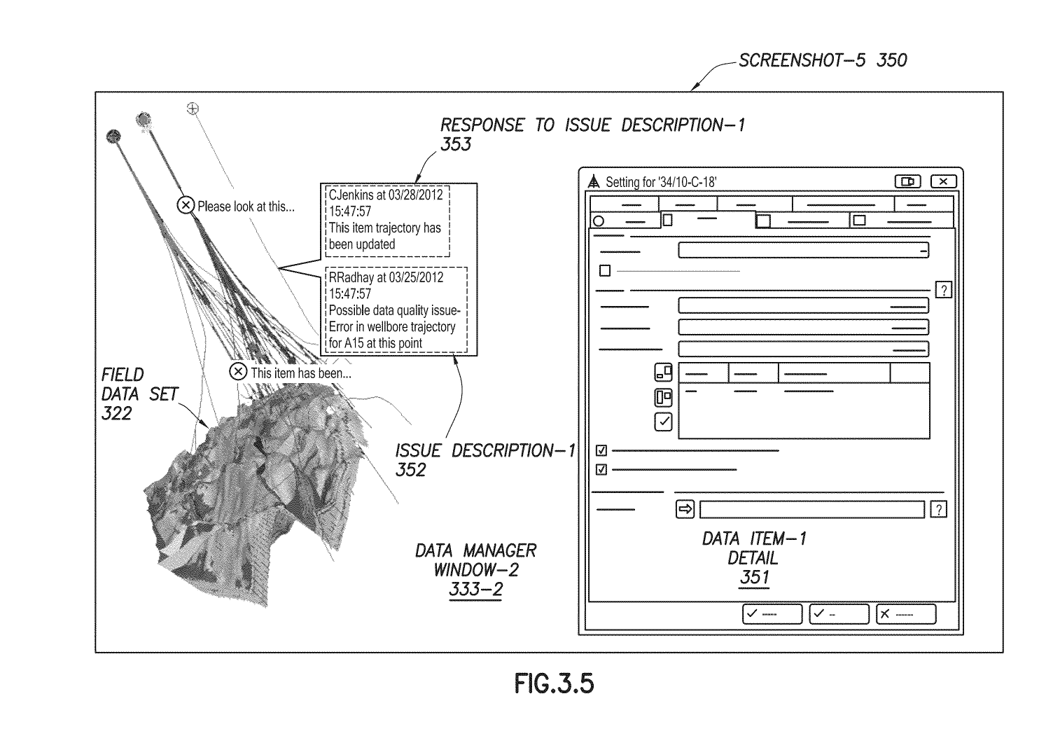

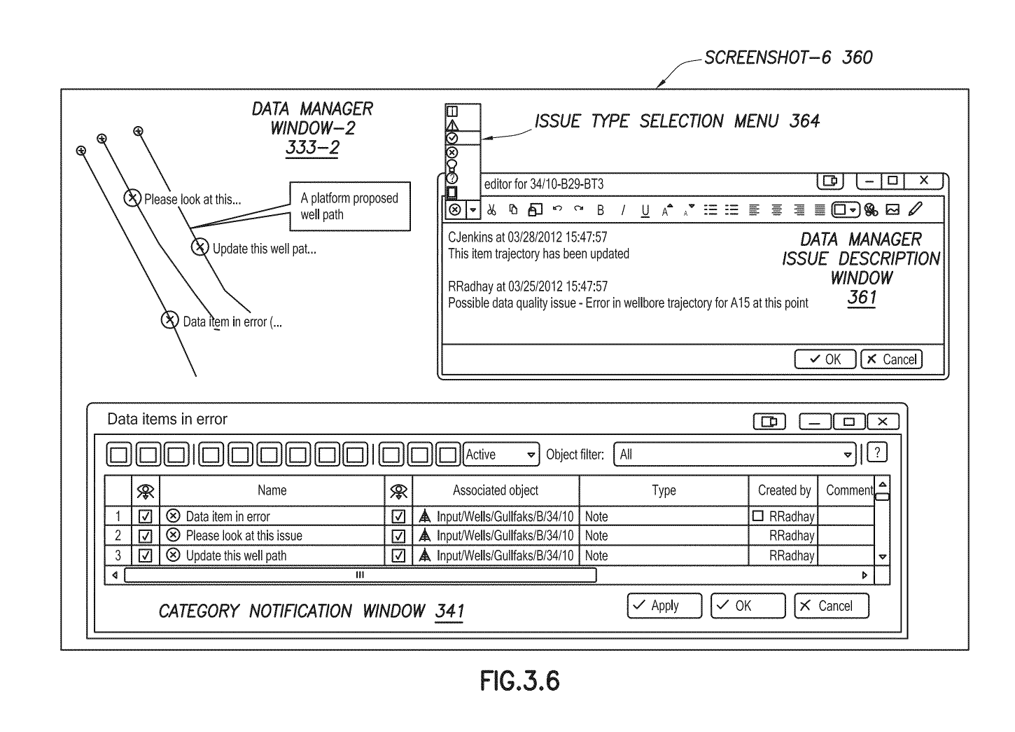

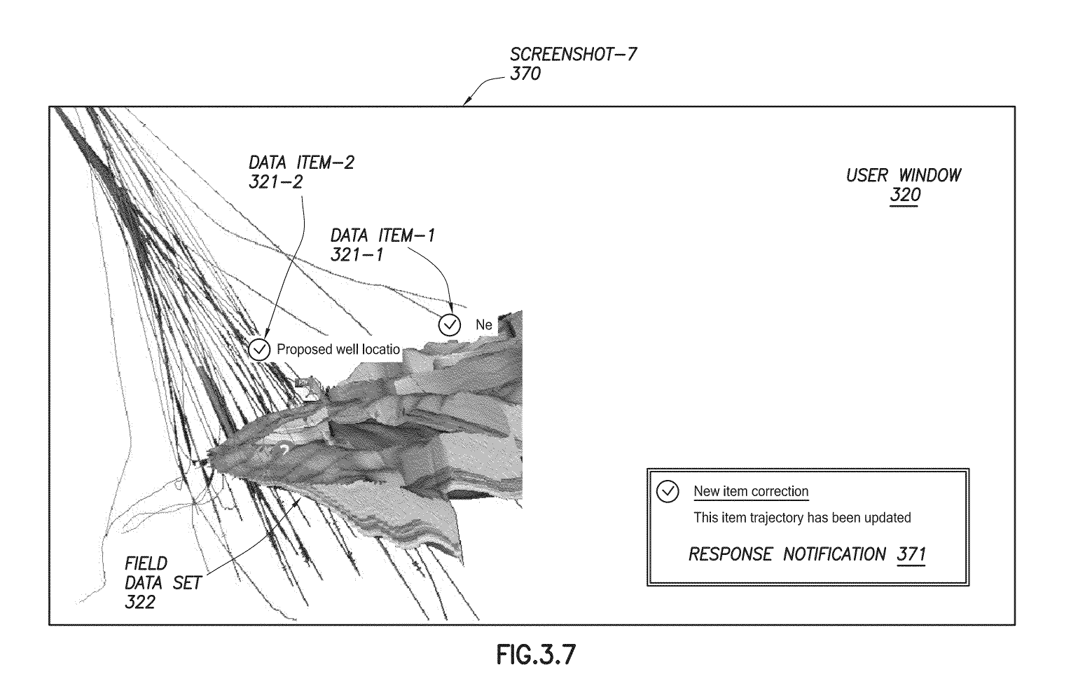

FIGS. 3.1-3.7 depict various screenshots that further illustrate the user sourced data issue management in accordance with one or more embodiments. In one of more embodiments, the example depicted in FIGS. 3.1-3.7 is practiced using the E&P computer system (208) described above.

FIG. 3.1 shows a workflow (310) for reporting data issue using the E&P computer system (208) described above. Initially, in block (311), a user of the E&P tool identifies a possible issue with data. In block (312), the user utilizes an annotation tool to add a note with a brief explanation of a possible data quality issue. In block (313), another user, who is the data manager of the E&P tool, is alerted via email of the new data quality alert. In block (314), the data manager launches another instantiation of the E&P tool, and is presented with a list of data issue annotations with their context. This list summarizes reported issues from multiple users and may be presented in a 2D or 3D view. In block (315), the data manager takes action by correcting the data or otherwise closes the issues. In addition, the data manager makes a quick note of the action taken to be recorded in the annotation. In block (316), the user who reported the issue is notified of the action taken. If the data is updated, the user has the option to immediately update data in his/her instantiation of the E&P tool for immediate viewing. The workflow (310) is further illustrated in the screenshots shown in FIGS. 3.2-3.7 below.

FIG. 3.2 shows a screenshot-2 (320) of a user window (321), which is a user interface window of the E&P tool for viewing the field data set (322). As shown, the field data set (322) is displayed as an image of the subterranean formation with a data item-1 (321-1) and a data item-2 (321-2) highlighted. Specifically, a geologist user has tagged a graphical element representing an annotation to the data item-1 (321-1) by entering an issue description using the user issue description window (323). In one or more embodiments, the user issue description window (323) may be selected from a drop down menu displayed by a user mouse click on the data item-1 (321-1). Further, the type (e.g., basic informative, notification, alert, etc.) of the reported issue may be selected by the user using the issue type selection menu (324) of the user issue description window (323). As shown, the user has selected the “X” mark icon from the issue type selection menu (324) to highlight the issue concerning the data item-1 (321-1). In contrast, the data item-2 (321-2) is highlighted by a check mark icon. For example, the “X” mark icon represents the type “Data error.”

Once the geologist creates the annotation, a data manager receives a notification of this newly created note flagged as a data error, which is stored in a repository that several users share. The data manager clicks to view the error notification and the underlying note as he receives it. He can choose an option on the note to restore the camera angle, colors, zoom level, etc. of the image displayed in the user window (321) shown in FIG. 3.2.

FIG. 3.3 shows a screenshot-3 (330) which includes the data manager window-1 (333-1) and the notification list (331). Specifically, the data manager launches the E&P tool, and is presented with data manager window-1 (333-1) and the notification list (331). As shown, the annotation created by the geologist corresponds to the notification-1 (332) in the notification list (331). In particular, the data manager window-1 (333-1) displays a data manager image that includes a substantially larger geographical extent than the geologist image shown in the user window (321) of FIG. 3.2. Accordingly, the data manager can monitor multiple users' issue reporting over multiple user project locations. Optionally, the notification list (331) can be displayed in a 2D or 3D format.

FIG. 3.4 shows a screenshot-4 (340), which is a portion of the notification list (331) in the 3D format. In particular, the notification list (331) is displayed in the data manager window-2 (333-2) as the 3D view of notifications (342). In one or more embodiments, the data manager window-2 (333-2) is a pop-up window overlaying (i.e., superimposed on) the data manager window-1 (332-1). As shown, the notification-1 (332) in the 3D view of notifications (342) is represented as the “X” mark icon previously selected by the geologist user. As shown in FIG. 3.4, three “X” mark icons in the 3D view of notifications (342) represent three issues reported by three users in the same issue type identified by the “X” mark. The corresponding three annotations reporting these issues are tabulated in the category notification window (341).

FIG. 3.5 shows a screenshot-5 (350), which is the same data manager window-2 (333-2) shown in FIG. 3.4 with the field data set (322) turned on and superimposed by the 3D view of notifications (342). As shown, the data manager has activated the data item-1 detail (351) corresponding to the annotation associated with the notification-1 (332). By viewing or otherwise analyzing the information of the data item-1 detail (351), the data manager has made a correction in the data item-1 detail (351) to address the issue reported in the annotation from the geologist. For example, the notification-1 (332) shown in FIG. 3.4 is expanded into the issue description-1 (352) to show the underlying annotation from the geologist. Specifically, the issue description-1 (352) includes the issue description that the geologist previously entered into the user issue description window (323) of FIG. 3.2. In addition, the issue description-1 (352) is concatenated with the response of the data manager to the issue description-1 (352).

FIG. 3.6 shows a screenshot-6 (360) of the data manger window-2 (333-2) showing an alternative way to enter the data manager's response. As shown, the issue description-1 (352) and the response to issue description-1 (353) are combined in the data manager issue description window (361). Further, the data manager issue description window (361) includes the issue type selection menu (364) to allow the data manager to update the “X” mark icon, previously tagged onto the data item-1 (321-1) by the geologist user, to the check mark icon indicating that the “Data error” type is changed to the “Corrected” type. Although not specifically shown in FIG. 3.6, the updated type will later be reflected in the category notification window (341).

An example scenario of the interaction between the user reporting the data issue and the data manager responding to the reported issue (i.e., the issue description-1 (352) and the response to issue description-1 (353)) is described below.

A geologist is doing an interpretation and sees that there has to be an error in the well data. He creates a note saying “The Kelly Bushing value at this point is wrong. Please check the well file and correct if necessary.” The “point” mentioned in the note is represented through the point at which the note is added in the user window-1 (321). Said in other words, all the context is given through the spatial representation of the well and the note in user window-1 (321). He tags the note type as “Data error”. There is an underlying setting for all notes tagged as a “Data error” which identifies the person (i.e., a designated data manager for this note type) to whom a notification will appear when a note of this type is created. Different data managers may be designated to receive different types of notifications. The Geologist saves the note which automatically creates and stores a viewing parameter in the note (transparent to the user) which holds:

(i) Camera angle of the view in the spatial window when note was captured (in this case 3D window).

(ii) All objects turned on in the user window-1 (321) when the note was captured, not only the object the note is being added to. In this manner, the full context of the environment (in which the note was captured) is included.

(iii) Colors, zoom level, etc.

Once notified, the data administrator checks the source well file (e.g., a paper document or an electronic file regarding the well) to confirm the value for the Kelly Bushing. He then updates the value for the well as a response, and generates the response to issue description-1 (353). The data manager then opens the note and adds some text saying the error has been fixed and changes the tag from a “Data error” flag to a “Corrected” flag. He then sends the note back to the repository, and the geologist user who created the note gets an update that the error has been fixed. The geologist user can open the note to see the updated content of the note saying error has been corrected. Instead of correcting the error, the data manager can also reply with a question and maintain communication in context of the data objects through the note with the geologist user. As illustrated in FIG. 3.4, the data manager can also turn on a data error layer (e.g., the 3D view of notifications (342) or the category notification window (341)) which will show all the data errors submitted by multiple users. For each data error, the view can be restored to show the context for any note before being corrected or answered. For example as illustrated in FIG. 3.5, the data manager window-2 (333-2) is a reproduction of the user window (321) of FIG. 3.2 based on the aforementioned viewing parameter (i.e., information (i) through (iii)) above.

The geologist user is notified of the action taken. If the data is updated, the geologist user has the option to immediately update local data with the corrected data and view it immediately. FIG. 3.7 shows a screenshot-7 (370), which represents the same user window (320) shown in FIG. 3.2. The data item-1 (321-1) is updated from the “X” mark icon to the check mark icon. In addition, the response notification (371) opens up to inform the geologist user of the new item correction from the data manager.

Embodiments of user sourced data issue management may be implemented on virtually any type of computer regardless of the platform being used. For instance, as shown in FIG. 4, a computer system (400) includes one or more processor(s) (402) such as a computer processor, a central processing unit (CPU), or other hardware processor, associated memory (405) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer (400) may also include input means, such as a keyboard (408), a mouse (410), or a microphone (not shown). Further, the computer (400) may include output means, such as a monitor (412) (e.g., a liquid crystal display LCD, a plasma display, or cathode ray tube (CRT) monitor). The computer system (400) may be connected to a network (415) (e.g., a local area network (LAN), a wide area network (WAN) such as the Internet, or any other similar type of network) via a network interface connection (not shown). Those skilled in the art will appreciate that many different types of computer systems exist (e.g., workstation, desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system (400) includes at least the minimal processing, input, and/or output means necessary to practice one or more embodiments.

Further, those skilled in the art will appreciate that one or more elements of the aforementioned computer system (400) may be located at a remote location and connected to the other elements over a network. Further, one or more embodiments may be implemented on a distributed system having a plurality of nodes, where each portion of the implementation may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform one or more embodiments may be stored on a computer readable medium such as a compact disc (CD), a diskette, a tape, or any other computer readable storage device.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While user sourced data issue management has been described with respect to a limited number of embodiments, those skilled in the art, having benefit of this disclosure, will appreciate that other embodiments may be devised which do not depart from the scope of user sourced data issue management as disclosed herein. Accordingly, the scope of user sourced data issue management should be limited only by the attached claims.

What is claimed is:

1. A method for operating an exploration and production (E&P) tool in a field having a subterranean formation, comprising:
displaying, in a first image generated by a first instantiation of the E&P tool, a plurality of graphical elements corresponding to a plurality of objects in the field;
receiving, by the first instantiation of the E&P tool and from a first user, a first annotation comprising a first issue description regarding a first data item of a wellbore in the plurality of objects;
tagging the first annotation onto a first graphical element representing the first data item of the wellbore, wherein the first annotation is stored in a repository and accessible by the first instantiation of the E&P tool and a second instantiation of the E&P tool;
sending a first notification to a second user regarding the first annotation; and
receiving, by a computer processor executing the second instantiation of the E&P tool and from the second user, a first response to the first issue description, wherein the first response is added to the first annotation and stored in the repository,
wherein the first response is accessible from the repository by the first user using the first instantiation of the E&P tool.

2. The method of claim 1, further comprising:
presenting, in response to the first user clicking on the first graphical element in the first image, a user issue description window associated with the first data item of the wellbore,
wherein the first data item of the wellbore comprises at least one selected from a group consisting of a wireframe representing the wellbore, a pixel image representing the wellbore, a test log associated with the wellbore, and a report file associated with the wellbore, and
wherein the first issue description is received from the first user via the user issue description window.

3. The method of claim 2,
wherein the first annotation further comprises a type of the first issue description, and
wherein the type identifies the first issue description as belonging to at least one selected from a group consisting of a first type regarding information of the first data item of the wellbore, a second type regarding an action applied to the first data item of the wellbore, and a third type regarding a problem of the first data item of the wellbore.

4. The method of claim 1, further comprising:
generating, in response to the first notification and by the second instantiation of the E&P tool, a second image as a reproduction of the first image for displaying to the second user, wherein the first data item of the wellbore and the first issue description are displayed in the second image for analysis by the second user,
wherein the first response to the first issue description is received in response to displaying the second image to the second user,
wherein the first annotation further comprises a configuration parameter for the first instantiation of the E&P tool, and
wherein the second image is generated based on the configuration parameter to reproduce the first image.

5. The method of claim 4, further comprising:
highlighting, in the second image, the first data item of the wellbore to indicate a notification status of the first data item of the wellbore with respect to the first issue description;
receiving, in response to the second user viewing the notification status, a request from the second user to display the first issue description; and
further highlighting, in the second image and in response to receiving the first response, the first data item of the wellbore to indicate a response status of the first data item of the wellbore with respect to the first response.

6. The method of claim 5, further comprising:
highlighting, in the first image and in response to receiving the first response, the first graphical element to indicate, to the first user, the response status of the first data item of the wellbore with respect to the first response.

7. The method of claim 6, further comprising:
receiving, from the first user and in response to the first user viewing the response status of the first data item of the wellbore, a second response, wherein the first issue description, the first response, and the second response are combined into an issue reporting/resolution log that is stored in the repository,
wherein the issue reporting/resolution log of the first data item of the wellbore is accessible from the repository by the first instantiation of the E&P tool and the second instantiation of the E&P tool.

8. The method of claim 7, further comprising:
receiving, by a third instantiation of the E&P tool and from a third user, a second annotation comprising a second issue description regarding a second data item of a subterranean formation layer in the plurality of objects, wherein the second annotation is stored in the repository and accessible by the first instantiation of the E&P tool, the second instantiation of the E&P tool, and the third instantiation of the E&P tool;
sending a second notification to the second user regarding the second annotation, wherein the second data item of the subterranean formation layer is displayed in the second image;
highlighting, in the second image, the second data item of the subterranean formation layer to indicate the notification status of the second data item of the subterranean formation layer with respect to the second issue description; and
displaying the first notification and the second notification in a notification list associated with the second image.

9. The method of claim 8,
wherein the issue reporting/resolution log of the first data of the wellbore are accessible from the repository by the first instantiation of the E&P tool, the second instantiation of the E&P tool, and the third instantiation of the E&P tool.

10. A system for operating an exploration and production (E&P) tool of a field having a subterranean formation, comprising:
a first display configured to display, in a first image to a first user by a first instantiation of the E&P tool, a plurality of graphical elements corresponding to a plurality of objects in the field;
a processor and memory;
a plurality of instantiations of an E&P tool that are stored in the memory, executing on the processor, and configured to:
receive, by the first instantiation of the E&P tool and from a first user, a first annotation comprising a first issue description regarding a first data item of a wellbore in the plurality of objects;
tag the first annotation onto a first graphical element representing the first data item of the wellbore, wherein the first annotation is stored in a repository and accessible by the first instantiation of the E&P tool and a second instantiation of the E&P tool;
send a first notification to a second user regarding the first annotation; and
receive, by a second instantiation of the E&P tool and from the second user, a first response to the first issue description, wherein the first response is added to the first annotation and stored in the repository; and
the repository configured to store the first annotation and the first response, wherein the first response is accessible by the first user using the first instantiation of the E&P tool.

11. The system of claim 10, wherein the first instantiation is further configured to:
present, in response to the first user clicking on the first graphical element in the first image, a user issue description window associated with the first data item of the wellbore,
wherein the first data item of the wellbore comprises at least one selected from a group consisting of a wireframe representing the wellbore, a pixel image representing the wellbore, a test log associated with the wellbore, and a report file associated with the wellbore, and
wherein the first issue description is received from the first user via the user issue description window.

12. The system of claim 11,
wherein the first annotation further comprises a type of the first issue description, and
wherein the type identifies the first issue description as belonging to at least one selected from a group consisting of a first type regarding information of the first data item of the wellbore, a second type regarding an action applied to the first data item of the wellbore, and a third type regarding a problem of the first data item of the wellbore.

13. The system of claim 10, wherein the second instantiation is further configured to:
generate, in response to the first notification, a second image as a reproduction of the first image for displaying to the second user, wherein the first data item of the wellbore and the first issue description are displayed in the second image for analysis by the second user,
wherein the first response to the first issue description is received in response to displaying the second image to the second user,
wherein the first annotation further comprises a configuration parameter for the first instantiation of the E&P tool, and
wherein the second image is generated based on the configuration parameter to reproduce the first image.

14. The system of claim 13, wherein the second instantiation is further configured to:
highlight, in the second image, the first data item of the wellbore to indicate a notification status of the first data item of the wellbore with respect to the first issue description;
receive, in response to the second user viewing the notification status, a request from the second user to display the first issue description; and
further highlight, in the second image and in response to receiving the first response, the first data item of the wellbore to indicate a response status of the first data item of the wellbore with respect to the first response.

15. The system of claim 14, wherein the first instantiation is further configured to:
highlight, in the first image and in response to the first instantiation receiving the first response, the first graphical element to indicate, to the first user, the response status of the first data item of the wellbore with respect to the first response.

16. The system of claim 15, wherein the first instantiation is further configured to:
receive, from the first user and in response to the first user viewing the response status of the first data item of the wellbore, a second response, wherein the first issue description, the first response, and the second response are combined into an issue reporting/resolution log that is stored in the repository,
wherein the issue reporting/resolution log of the first data item of the wellbore is accessible from the repository by the first instantiation of the E&P tool and the second instantiation of the E&P tool.

17. The system of claim 16,
wherein a third instantiation of the E&P tool is configured to:
receive, from a third user, a second annotation comprising a second issue description regarding a second data item of a subterranean formation layer in the plurality of objects, wherein the second annotation is stored in the repository and accessible by the first instantiation of the E&P tool, the second instantiation of the E&P tool, and the third instantiation of the E&P tool; and
send a second notification to the second user regarding the second annotation,
wherein the second instantiation is further configured to:
display, in the second image, the second data of the subterranean formation layer;
highlight, in the second image, the second data item of the subterranean formation layer to indicate the notification status of the second data item of the subterranean formation layer with respect to the second issue description; and
display the first notification and the second notification in a notification list associated with the second image.

18. The system of claim 17,
wherein the issue reporting/resolution log of the first data of the wellbore are accessible from the repository by the first instantiation of the E&P tool, the second instantiation of the E&P tool, and the third instantiation of the E&P tool.

19. A non-transitory computer readable medium storing instructions for operating an exploration and production (E&P) tool of a field having a subterranean formation, the instructions, when executed by a computer processor comprising functionality for:
displaying, in a first image generated by a first instantiation of the E&P tool, a plurality of graphical elements corresponding to a plurality of objects in the field;
receiving, by the first instantiation of the E&P tool and from a first user, a first annotation comprising a first issue description regarding a first data item of a wellbore in the plurality of objects;
tagging the first annotation onto a first graphical element representing the first data item of the wellbore, wherein the first annotation is stored in a repository and accessible by the first instantiation of the E&P tool and a second instantiation of the E&P tool;
sending a first notification to a second user regarding the first annotation; and
receiving, by the second instantiation of the E&P tool and from the second user, a first response to the first issue description, wherein the first response is added to the first annotation and stored in the repository,
wherein the first response is accessible from the repository by the first user using the first instantiation of the E&P tool.

20. The non-transitory computer readable medium of claim 19, the instructions, when executed by the computer processor further comprising functionality for:
presenting, in response to the first user clicking on the first graphical element in the first image, a user issue description window associated with the first data item of the wellbore,
wherein the first data item of the wellbore comprises at least one selected from a group consisting of a wireframe representing the wellbore, a pixel image representing the wellbore, a test log associated with the wellbore, and a report file associated with the wellbore, and
wherein the first issue description is received from the first user via the user issue description window.
